(19) United States
(12) Patent Application Publication
(10) Pub. No.: US 2026/0224951 A1
(43) Pub. Date: Aug. 6, 2026

(54) GOLF BAG CART WITH IMPROVED STABILITY AND DUAL BAG CAPACITY

(71) Applicant: Michael Jong CHOI, Fairfax, VA (US)

(72) Inventor: Michael Jong CHOI, Fairfax, VA (US)

(21) Appl. No.: 19/634,152

(22) Filed: Mar. 31, 2026

Related U.S. Application Data
(63) Continuation-in-part of application No. 19/046,833, filed on Feb. 6, 2025.

(51) Int. Cl. A63B 55/60; B62B 1/12; B62B 1/14; B62B 1/26; B62B 5/06; B62B 5/08

(52) U.S. Cl. CPC A63B 55/60; B62B 1/12; B62B 1/14; B62B 1/264; B62B 1/266; B62B 5/065; B62B 5/085; A63B 2055/601; B62B 2202/404

(57) ABSTRACT

According to one embodiment, a golf bag includes a front frame have a lower end and an upper end, a rear frame coupled to a rear of the front frame to support the front frame, a plurality of wheels positioned at lower ends of the front frame and the rear frame, a handle structure coupled to the upper end of the front frame, and a recessed accommodation groove to accommodate a golf bag. The front frame and the rear frame are directly connected via a folding linkage configured to reduce a distance between the front frame and the rear frame in a folded state. The handle structure comprises a cross-bar handle connecting a left side and a right side of the upper end of the front frame. The front frame includes a base plate at the lower end configured to support a bottom of the golf bag.

### CROSS-REFERENCE TO RELATED APPLICATION

This application is a continuation-in-part of U.S. patent application Ser. No. 19/046,833, filed on Feb. 6, 2025, the disclosure of which is incorporated herein by reference in its entirety.

### BACKGROUND OF THE DISCLOSURE

### Field of the Disclosure

The present disclosure relates to a golf bag cart, which is designed to assist in the stable transport of a golf bag or multiple golf bags during golf play while walking for exercise purposes.

### Background Art

In general, to use a golf bag on the field, the golf bag is loaded and transported on a transport device such as a cart or is moved by a person carrying the golf bag on the shoulder or back while walking. Accordingly, a golf bag cart is designed to be relatively compact and to transport golf bags stably.

The golf bag cart includes: a base plate on which the golf bag can be placed; a frame which is connected to the base plate and forms the exterior of the golf bag cart; and wheels provided at the bottom of the frame.

A user can move the golf bag cart by holding a handle of the golf bag cart and pushing the frame forward. Conventionally, during the movement, it is common for the golf bag to shift sideways and separated from the base plate and the frame, falling to the ground.

Additionally, the conventional golf bag cart generally features a one-push bar-style handle structure, so the user moves the golf bag cart while pushing the golf bag cart with one hand. Due to the limit of imbalance during movement, the golf bag cart frequently loses balance and overturns, or the golf bag is separated from the golf bag cart.

Additionally, many conventional golf bag carts are equipped with three wheels and a one-push bar-style handle structure. In such cases, on an uneven slope, the golf bag cart often loses balance, tilts sideways, and falls or overturns. In this instance, golf clubs may be separated from the golf bag.

In addition, due to the structural problem of the conventional golf bag carts, which are designed to be pushed only with one hand, the conventional golf bag carts increase the fatigue of the user's waist and legs.

### SUMMARY OF THE DISCLOSURE

Therefore, the present disclosure proposes a golf bag cart equipped with a two-push bar-style handle structure, such as a two-push bar-style or a continuous cross-bar style, that allows the user to push and move the golf bag cart with both hands, enabling the golf bag cart to also function as a walker.

Furthermore, there is a need for a golf bag cart capable of transporting multiple golf bags simultaneously, such as for couples or coaches, without compromising stability. There is also a need for improved compactness in the folded state for vehicle transport.

Accordingly, the present disclosure has been made to solve the above-mentioned problems occurring in the prior arts, and it is an objective of the present disclosure to provide a golf bag cart that prevents the cart from easily overturning during the transportation of a golf bag, stably prevents the golf bag from being separated from the golf bag cart, and functions as a walker to reduce a user's waist and leg fatigue.

To accomplish the above object, according to one embodiment of the present disclosure, there is provided a golf bag cart capable of placing and transporting a golf bag, including a front frame having a lower end and an upper end, a rear frame coupled to a rear side of the front frame to support the front frame, a plurality of wheels positioned at lower ends of the front frame and the rear frame, and a handle structure coupled to the upper end of the front frame, and a recessed accommodation groove to accommodate a golf bag, wherein the front frame and the rear frame are directly connected via a folding linkage configured to reduce a distance between the front frame and the rear frame in a folded state, wherein the handle structure comprises a cross-bar handle connecting a left side and a right side of the upper end of the front frame, and wherein the front frame includes a base plate at the lower end configured to support a bottom of the golf bag.

In one embodiment, the folding linkage comprises a Z-shaped linkage when folded configured to fold to minimize the distance between the front frame and the rear frame. In one embodiment, the cross-bar handle is telescopically adjustable in height relative to the front frame. In one embodiment, the cross-bar handle comprises a push-button locking mechanism to secure the handle at a selected height.

In one embodiment, the golf bag cart further comprises a seat mounted between the front frame and the rear frame, wherein the seat is sized to extend rearward beyond the rear frame to provide clearance for a user's legs during walking. In one embodiment, the base plate has a semi-cylindrical shape with a depth of three inches or less and a diameter of ten inches or less. In one embodiment, the recessed accommodation groove has a rectangular cross-sectional profile to provide a flat contact surface for the golf bag. In one embodiment, the recessed accommodation groove includes a plurality of strap holes, including a pair of inner holes for securing a small-diameter golf bag and a pair of outer holes for securing a regular-diameter golf bag.

In one embodiment, the front frame comprises three points of support for the golf bag: the base plate at the lower end, the recessed accommodation groove at a middle portion, and the seat at an upper portion. In one embodiment, the plurality of wheels has a diameter of approximately ten inches to facilitate movement over a rough terrain. In one embodiment, the plurality of wheels comprises front wheels having a diameter of approximately nine inches and rear wheels having a diameter of approximately ten inches.

In one embodiment, the golf bag cart is configured as a dual golf bag cart, wherein the front frame comprises a parallel rack arrangement configured to support two golf bags side-by-side. In one embodiment, the front frame includes two distinct base plates and two distinct recessed accommodation groove sets to independently secure the two golf bags.

As described above, the golf bag cart according to the present disclosure can restrict the lateral movement of the golf bag by a cover surface while the golf bag is positioned in the recessed accommodation groove, thereby preventing the golf bag from being separated from the golf bag cart more effectively while the user moves the golf bag placed thereon. Additionally, the golf bag cart according to the present disclosure, which is a new type of golf bag cart including four wheels and two handles and/or a cross-bar handle, can prevent the cart from easily overturning during the transportation of a golf bag, stably prevent the golf bag from being separated from the golf bag cart, and function as a walker to reduce the user's waist and leg fatigue. In addition, the golf bag cart according to the present disclosure additionally includes the supporter accommodation groove, allowing the golf bag to be stably positioned within the recessed accommodation groove with sufficient restriction of lateral movement.

### BRIEF DESCRIPTION OF THE DRAWINGS

FIG. 1 is a perspective view illustrating a state in which a golf bag is placed on a golf bag cart according to an embodiment of the present disclosure.

FIG. 2 is a perspective view of the golf bag cart in FIG. 1 according to an embodiment of the present disclosure.

FIG. 3 is an exploded perspective view of the golf bag cart in FIGS. 1 and 2 according to an embodiment of the present disclosure.

FIG. 4 is a plan view illustrating a state in which the golf bag is accommodated in a recessed accommodation groove of the golf bag cart in FIGS. 1 and 2 according to an embodiment of the present disclosure.

FIG. 5 is a plan view illustrating a modified example of FIG. 4.

FIG. 6 is a perspective view illustrating a seat of the golf bag cart in FIGS. 1 and 2 according to an embodiment of the present disclosure.

FIG. 7 is a bottom view of the seat in FIG. 6.

FIG. 8 is a diagram illustrating a state in which a supporter extends from the golf bag to support a golf bag body.

FIG. 9 is a perspective view illustrating a golf bag cart featuring a direct frame connection via a folding linkage and a cross-bar handle according to an embodiment of the present disclosure.

FIG. 10 is a perspective view illustrating a state in which a golf bag is placed on the golf bag cart of FIG. 9 according to an embodiment of the present disclosure.

FIG. 11 is a perspective view of a rectangular recessed accommodation groove for the golf bag cart in FIGS. 9 and 10 having inner and outer strap holes according to an embodiment of the present disclosure.

FIG. 12 is a perspective view of a dual golf bag cart according to an embodiment of the present disclosure.

### DETAILED DESCRIPTION OF THE DISCLOSURE

Hereinafter, embodiments of the present disclosure will be described in more detail with reference to the accompanying drawings. However, the present disclosure is not limited to the embodiments disclosed below and may be realized in various other forms. The exemplary embodiments are provided so that the present disclosure is completely disclosed, and a person of ordinary skilled in the art can fully understand the scope of the present disclosure. In the drawings, the same reference numerals refer to the same elements.

A golf bag cart according to a preferred embodiment of the present disclosure includes a recessed accommodation groove, allowing the golf bag to be stably supported when accommodated inside to ensure the golf bag in a more securely mounted state. Furthermore, the golf bag cart can more stably prevent the golf bag from being separated from the golf bag cart during transportation.

Additionally, the present disclosure provides a two-push bar style handle structure, enabling the user to push the golf bag cart with both hands while moving, so serving a walker function.

Hereinafter, the present disclosure will be described in detail with reference to the embodiments.

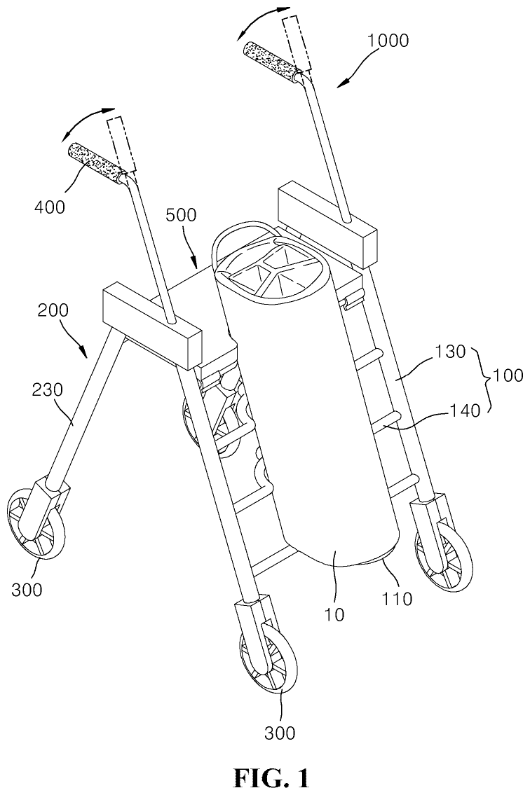

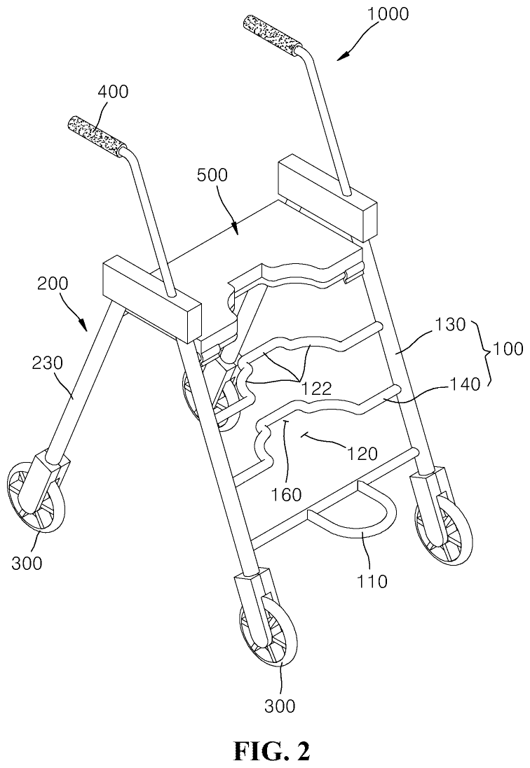

As illustrated in FIGS. 1 and 2, the golf bag cart 1000 according to an embodiment of the present disclosure, which transports a golf bag 10 by placing the golf bag 10 thereon, includes a front frame 100, a rear frame 200, moving wheels 300, and handles 400. A user can utilize the golf bag cart 1000 for transporting a golf bag on a golf course or as a walker to assist the user in walking with straight back and spine in a correct posture.

The front frame 100 is made of a metallic material and provides a contact support surface for the golf bag 10. The rear frame 200 is coupled to the rear of the front frame 100 and is arranged to support the front frame 100. The front frame 100 and the rear frame 200 may be made of metal or plastic materials with sufficient rigidity.

The front frame 100 is inclined relative to the ground, and includes a golf bag support 110 formed to protrude from a lower portion of the front frame 100 to support the golf bag 10 from below.

The moving wheels 300 are respectively provided at the lower ends of the front frame 100 and the rear frame 200. In the embodiment of the present disclosure, for example, four moving wheels may be provided. Additionally, a plurality of handles 400 are arranged at the upper end of the front frame 100, for example, two handles are provided. The user can transport the golf bag on the golf bag cart by pushing the golf bag cart while holding the two handles 400 (two push bar style handle structure) or can use the golf bag cart as a walker, as described above.

As described above, the present disclosure proposes a new type of golf bag cart with four moving wheels 300 and two handles 400. The golf bag cart can prevent the golf bag cart from easily overturning during the transportation of the golf bag, stably prevent the golf bag from being separated from the golf bag cart, and function as a walker to reduce the user's waist and leg fatigue.

Additionally, differently from the conventional golf bag cart, the golf bag cart according to the present disclosure has a new type structure including four moving wheels 300 and two handles 400, thus significantly improving balance and stability during movement. In other words, the golf bag cart can prevent situations where the golf bag cart loses balance, tilts sideways, or overturns during movement on an uneven slope.

Here, the handle 400 may include a hinge structure to variably adjust an installation angle relative to the front frame 100. Additionally, the handle 400 may be configured to allow length adjustment.

As illustrated in FIGS. 1 to 5, the front frame 100 includes a recessed accommodation groove 120 recessed to support the golf bag 10 in an accommodated state.

Specifically, the front frame 100 includes a pair of first support frames 130 and a plurality of front connection frames 140.

The pair of first support frames 130 are directly connected to the rear frame 200 and arranged apart from each other. The plurality of front connection frames 140 are arranged apart from each other in the longitudinal direction of the pair of first support frames 130 and connect the pair of first support frames 130. Here, the recessed accommodation groove 120 is formed in the plurality of front connection frames 140. The recessed accommodation groove 120 may be formed in all or some of the front connection frames 140.

In the embodiment of the present disclosure, as illustrated in FIG. 1, the pair of first support frames 130 are inclined relative to the ground, and an inclination angle (tilt angle) may range from 30 to 80 degrees.

In addition, the inclination angle can preferably provide a sense of stability by slightly lowering the overall height of the golf bag cart. If the inclination angle is too steep, the user's forward view may be obstructed by the golf bag 10 when the golf bag 10 is placed, leading to inconvenience in movement and decreased operational safety.

The plurality of recessed accommodation grooves 120 formed in the plurality of front connection frames 140 are arranged parallel to each other. Therefore, when the golf bag 10 is placed, the plurality of front connection frames 140 are positioned inside the recessed accommodation grooves 120 in the longitudinal direction of the golf bag 10.

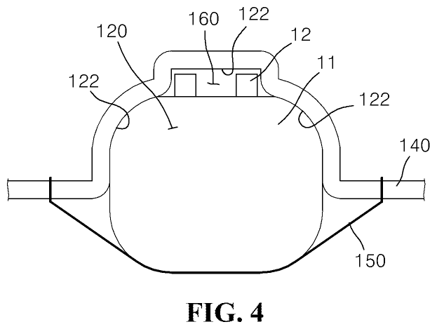

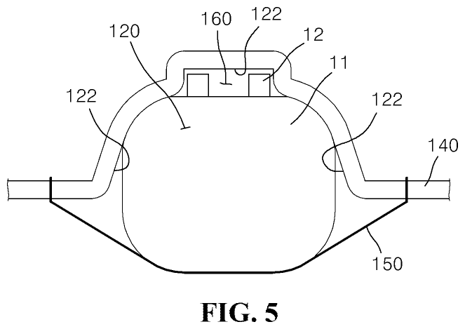

In the embodiment of the present disclosure, as illustrated in FIGS. 4 and 5, the recessed accommodation groove 120 includes a cover surface 122 that includes selection points and covers at least one-third of the circumferential surface of the golf bag 10, based on any selection point selected arbitrarily in the longitudinal direction of the golf bag 10. Preferably, the recessed accommodation groove 120 provides the cover surface 122 that covers at least one-half of the circumferential surface of the golf bag 10.

Here, as illustrated in FIG. 4, the cover surface 122 refers to a surface that directly contacts the outer surface of the golf bag 10 or, as illustrated in FIG. 5, is a surface that is arranged in close proximity within a certain distance from the outer surface of the golf bag 10.

The cover surface 122 is formed on a portion of the pair of first support frames 130, which form the recessed accommodation groove 120 and face the outer surface of the golf bag 10.

In other words, in the embodiment of the present disclosure, the golf bag 10 is restricted from lateral movement to a certain extent by the cover surface 122 when placed in the recessed accommodation groove 120, thereby further preventing the golf bag from being detached from the golf bag cart 1000 while the golf bag cart transports the golf bag by the user.

As illustrated in FIGS. 4 and 5, a strap 150 may be further provided on the plurality of front connection frames 140 to wrap around the front portion of the golf bag 10 placed in the recessed accommodation groove 120 to prevent the golf bag 10 from being separated forward. The strap 150 can be made of elastic material to further prevent the golf bag from being separated from the golf bag cart 1000. To selectively allow or restrict the forward movement of the golf bag 10, the user can freely wrap the front portion of the golf bag 10 using the strap 150.

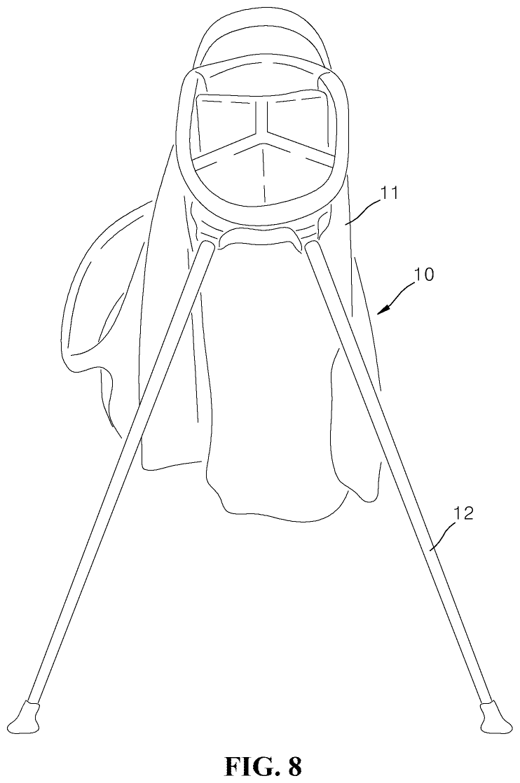

In general, as illustrated in FIGS. 4, 5, and 8, the golf bag 10 includes a golf bag body 11 and a plurality of supporters 12 which are rotatably attached to the golf bag body 11 to allow the golf bag body 11 to stand on the ground.

In the embodiment of the present disclosure, as illustrated in FIGS. 2 to 5, the plurality of front connection frames 140 are provided with supporter accommodation grooves 160 which are concaved inwardly as part of the recessed accommodation groove 120 to support the plurality of supporters 12 accommodated inside, excluding the golf bag body 11.

Thus, when the golf bag body 11 is placed in the recessed accommodation groove 120, and the plurality of supporters 12 are accommodated in the supporter accommodation grooves 160.

In a folded state, the plurality of supporters 12 protrude from the outer surface of the golf bag body 11. If the supporter accommodation grooves 160 were not provided, it might be difficult to maintain the stable arrangement of the golf bag 10 that the plurality of supporters 12 restrict the lateral movement of the golf bag 10 inside the recessed accommodation groove 120. However, with the provision of the supporter accommodation grooves 160, the golf bag 10 can be stably placed in the recessed accommodation groove 120 with sufficient lateral movement restriction.

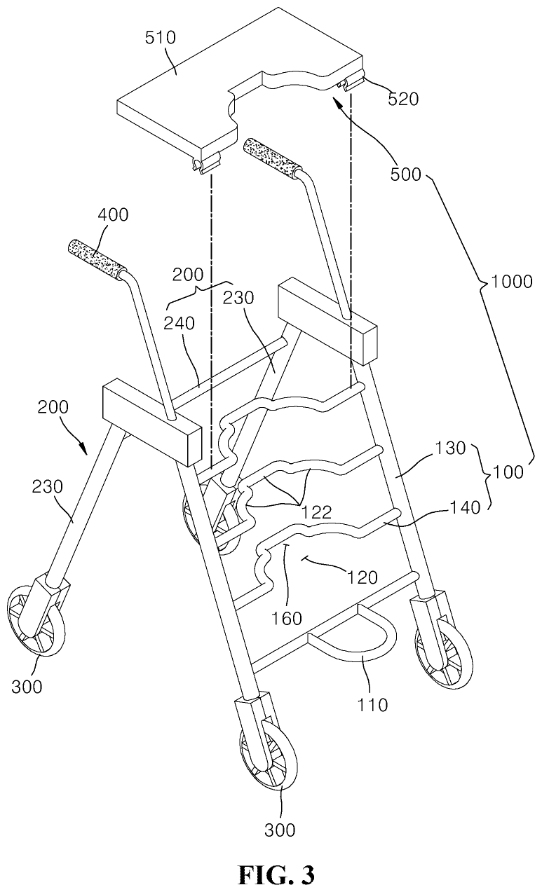

As illustrated in FIGS. 2 and 3, the rear frame 200 includes a pair of second support frames 230 and a plurality of rear connection frames 240.

The pair of second support frames 230 are coupled to the rear side of the pair of first support frames 130, and spaced apart from each other to support the pair of first support frames 130. The plurality of rear connection frames 240 are spaced apart from each other in the longitudinal direction of the pair of second support frames 230 and connect the pair of second support frames 230.

In the embodiment of the present disclosure, the front connection frames 140 and the rear connection frames 240 may be formed in a tubular shape, such as a circular tube.

In the embodiment of the present disclosure, although not specifically illustrated in the drawings, the front frame 100 and the rear frame 200 can be connected via a foldable connection structure.

Thus, after completing a golf game, the user can fold the golf bag cart to reduce the overall volume, making it easier to carry and store. The foldable connection structure may include a hinge shaft connected to the front frame 100 and the rear frame 200 via a rod or a bar. Besides the foldable connection structure, other known structures can be applied.

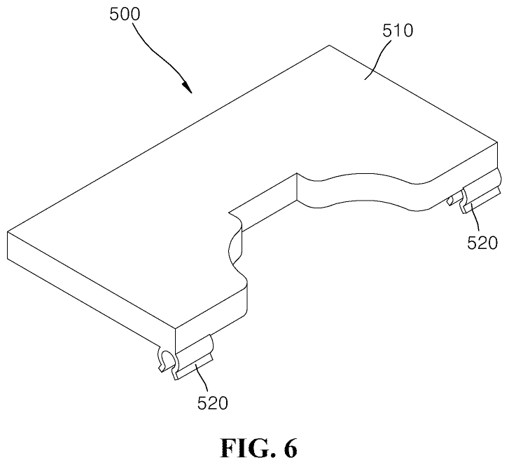

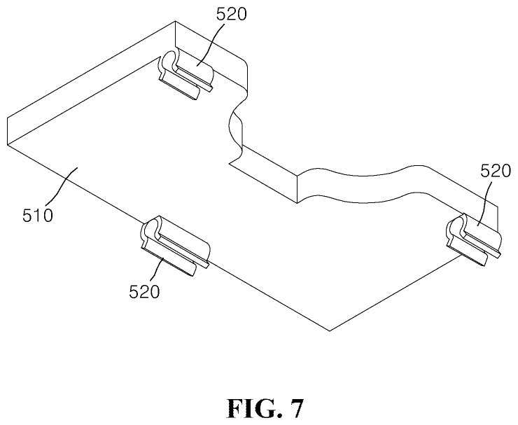

In the embodiment of the present disclosure, as illustrated in FIGS. 2, 3, 6, and 7, a seat 500 may be provided to connect corresponding front connection frames 140 and rear connection frames 240 with each other among the plurality of front connection frames 140 and rear connection frames 240.

Additionally, when the front connection frames 140 and the rear connection frames 240 are provided in the plural, the seat 500 may be installed to connect the uppermost front connection frame 140 and the uppermost rear connection frame 240.

As illustrated in FIGS. 2 and 3, the seat 500 may include: a seat body 510; and a plurality of clamps 520 provided at the lower portion of the seat body 510, and coupled with the front connection frame 140 and the rear connection frame 240, which are tubular, using a one-touch push mechanism.

The clamp 520 may have an approximately “C”-shaped cross-sectional structure and is preferably made of an elastic material to allow elastic deformation. After moving the seat 500 downward from above the front connection frame 140 and the rear connection frame 240, the user can easily couple the clamp 520 to the front connection frame 140 and the rear connection frame 240 by pressing downwardly the seat 500 above the front connection frame 140 and the rear connection frame 240 in a one-touch push manner. Once the seat 500 is coupled, the user can sit on the seat.

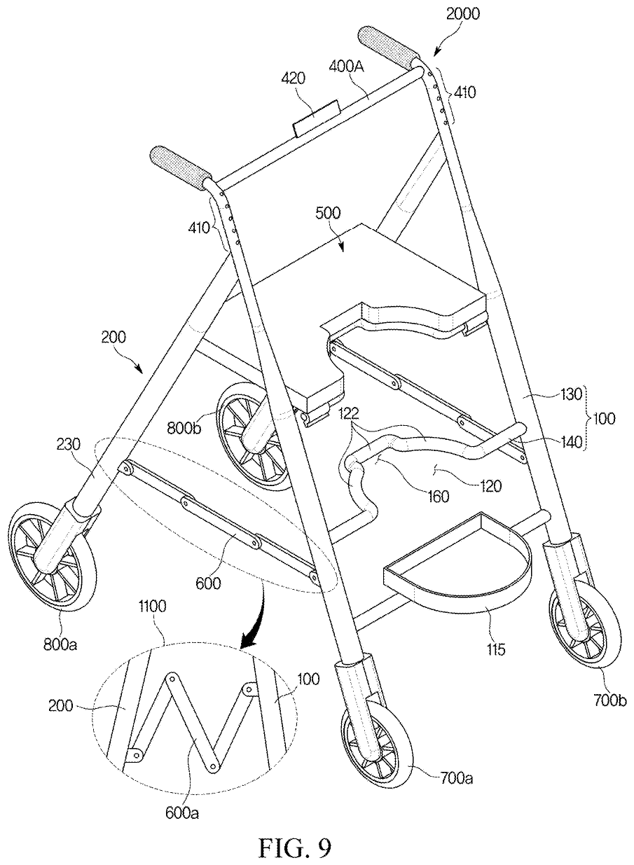

FIGS. 9 through 12 illustrate embodiments of a golf bag cart 2000 designed for enhanced stability, compactness, and dual-bag capacity.

FIG. 9 is a perspective view illustrating the golf bag cart 2000 featuring a direct frame connection via a folding linkage and a cross-bar handle, according to an embodiment of the present disclosure. As illustrated in FIG. 9, the golf bag cart 2000 comprises the front frame 100 and the rear frame 200 directly connected via a folding linkage 600, such as a Z-shaped folding linkage 600a. In one example embodiment, the Z-shaped folding linkage 600a allows the gap between the front frame 100 and the rear frame 200 to be minimized when folded, as illustrated in an exploded view 1100, thus significantly reducing the overall volume of the golf cart 2000 for transport. Alternatively, the folding linkage 600 is realized using an A-shaped folding linkage (not shown). In one embodiment, the seat 500 is sized to extend rearward (e.g., by 1 to 2 inches beyond the rear frame) to ensure sufficient sitting area despite the narrower gap caused by the direct frame connection, without interfering with the user's walking stride. The wheels of the golf bag cart 2000 are preferably enlarged to a diameter of an appropriate size to facilitate movement over rough terrain. In one example embodiment, the size of each wheel is approximately 10 inches. Alternatively, the golf back cart 2000 are configured with 9-inch front wheels 700a & 700b and 10-inch rear wheels 800a & 800 b.

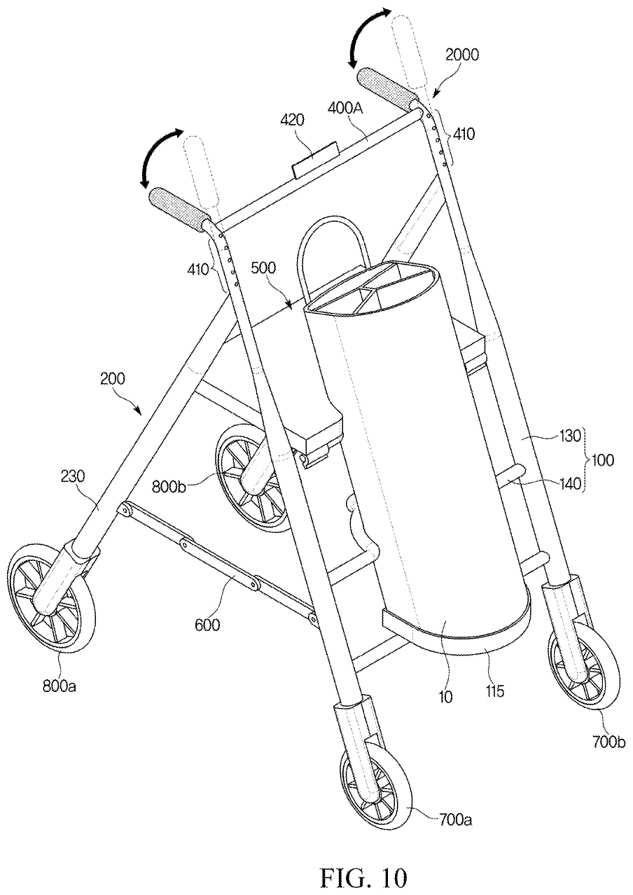

As illustrated in FIG. 9, the front frame 100 includes the recessed accommodation groove 120 recessed to support the golf bag 10 in an accommodated state, as illustrated in FIG. 10. Specifically, the front frame 100 includes a pair of first support frames 130 and a front connection frame 140. The pair of first support frames 130 are directly connected to the rear frame 200 and arranged apart from each other. The front connection frame 140 is arranged in the longitudinal direction of the pair of first support frames 130 and connects the pair of first support frames 130.

Here, the recessed accommodation groove 120 is formed in the front connection frame 140. In the embodiment of the present disclosure, as illustrated in FIGS. 4 and 5, the recessed accommodation groove 120 includes the cover surface 122 that includes selection points and covers at least one-third of the circumferential surface of the golf bag 10, based on any selection point selected arbitrarily in the longitudinal direction of the golf bag 10. Preferably, the recessed accommodation groove 120 provides the cover surface 122 that covers at least one-half of the circumferential surface of the golf bag 10. The front connection frame 140 is provided with the supporter accommodation grooves 160 which are concaved inwardly as part of the recessed accommodation groove 120 to support the plurality of supporters 12 accommodated inside, excluding the golf bag body 11, as detailed in FIGS. 4 and 5. The front frame 100 is inclined relative to the ground, and includes a base plate 115 formed to protrude from the lower portion of the front frame 100 to support the golf bag 10 from below. In one embodiment, the front frame 100 includes the base plate 115 at the lower end, replacing or supplementing the simple golf bag support 110 of FIGS. 1 through 3. In one example embodiment, the base plate 115 is a semi-cylindrical shape with a depth of approximately 3 inches or less and a diameter of approximately 10 inches or less, designed to firmly cup the hard plastic bottom of a standard golf bag.

As shown in FIG. 9, a handle structure 400A is formed as a continuous cross-bar handle connecting the left and right sides of the upper end of the front frame 100. This cross-bar design facilitates easier one-handed maneuvering (pulling) while turning, while maintaining the two-handed (walker-style) pushing capability. The front frame 100 includes a telescopic height adjustment mechanism 410 built on the font frame 100. It is appreciated that the telescopic height adjustment mechanism 410 with a pin-bolt is a system that uses a retractable pin or bolt to lock two sliding tubes together at specific, pre-drilled intervals. It is one of the most common and cost-effective methods for adjusting height in items like ladders, camera tripods, classroom furniture, etc. The telescopic height adjustment mechanism 410 relies on the alignment of holes between an inner and outer tube. The outer tube remains stationary or provides the housing, while the inner tube slides to adjust the height, where a series of holes are drilled at fixed distances along the length of the tubes, a metal or heavy-duty plastic pin that passes through the aligned holes physically blocks the tubes from moving, and many high-use systems use a spring-loaded pin (often called a button pin) that automatically “snaps” into the next available hole as the user slides the tubes.

A push-button system 420 (e.g., a green push button actuating a pin bolt of the telescopic height adjustment mechanism 410) formed in the middle of the handle structure 400A allows the handle structure 400A to be raised for use or lowered completely to minimize height during storage or to prevent interference with the user's head or back when sitting on the seat 500. That is, the user may be able to extend or reduce the height of the handle structure 400A while pressing the green push button.

FIG. 10 is a perspective view illustrating a state in which the golf bag 10 is placed on the golf bag cart 2000 of FIG. 9 according to an embodiment of the present disclosure. In the embodiment of the present disclosure, as illustrated in FIG. 9, the pair of first support frames 130 are inclined relative to the ground, and an inclination angle (tilt angle) may range from 30 to 80 degrees. In addition, the inclination angle can preferably provide a sense of stability by slightly lowering the overall height of the golf bag cart 2000. If the inclination angle is too steep, the user's forward view may be obstructed by the golf bag 10 when the golf bag 10 is placed, leading to inconvenience in movement and decreased operational safety.

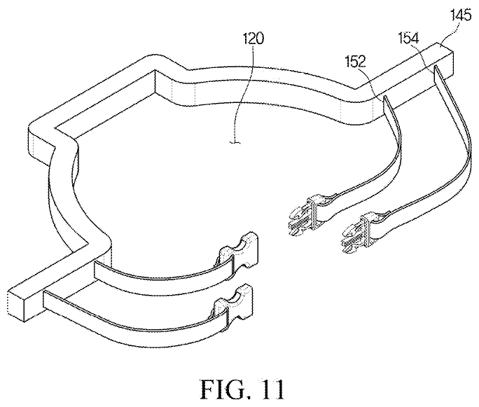

FIG. 11 is a perspective view of a rectangular recessed accommodation groove for the golf bag cart 2000 in FIGS. 9 and 10 having inner and outer strap holes according to an embodiment of the present disclosure. As illustrated in FIG. 11, the recessed accommodation groove 120 is preferably formed with a rectangular (square) cross-sectional profile 145 rather than a circular pipe shape, providing a wider contact area for the golf bag 10. The groove structure includes a plurality of strap holes: a pair of inner holes 152 for securing small-diameter golf bags, and a pair of outer holes 154 for securing regular-diameter golf bags.

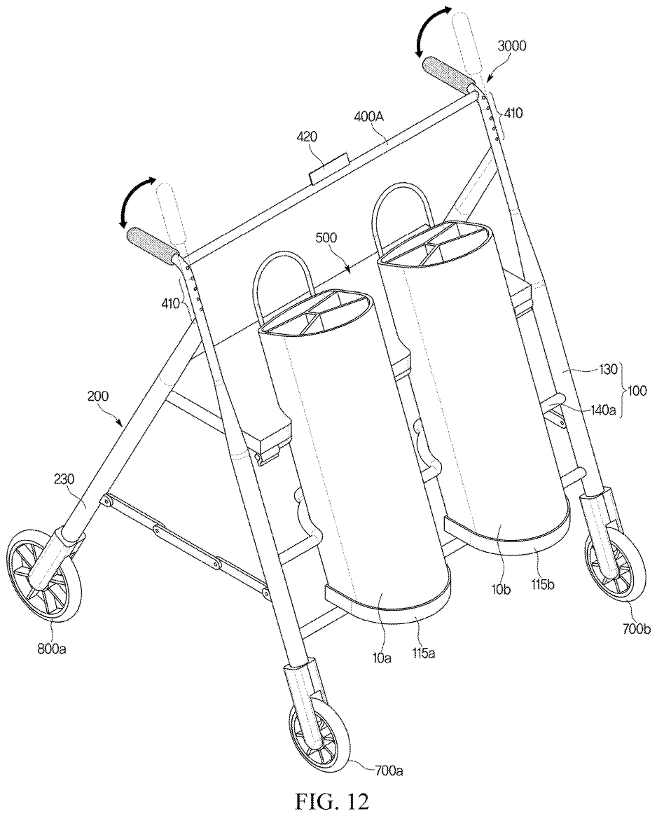

FIG. 12 is a perspective view of a dual golf bag cart 3000, according to an embodiment of the present disclosure. In this configuration, the frame is widened or duplicated in a parallel rack arrangement to accommodate two golf bags (e.g., 10a & 10b) side-by-side. The front frame 100 includes two distinct base plates (e.g., 115a & 115b) and two distinct recessed accommodation groove sets 140a to independently secure the two golf bags. This embodiment utilizes the improved stability of the four-wheel base and the structural rigidity of the cross-bar handle to support the additional load.

As described above, although the present disclosure has been described in connection with the preferred embodiment for illustrating the principle of the present disclosure, the present disclosure is not limited to the aforementioned specific embodiments. It will be appreciated to those skilled in the art that the present disclosure can be changed and modified in various manners without departing from the spirit and scope of the present disclosure.

What is claimed is:

1. A golf bag cart, comprising:
a front frame having a lower end and an upper end;
a rear frame coupled to a rear side of the front frame to support the front frame;
a plurality of wheels positioned at lower ends of the front frame and the rear frame;
a handle structure coupled to the upper end of the front frame; and
a recessed accommodation groove to accommodate a golf bag,
wherein the front frame and the rear frame are directly connected via a folding linkage configured to reduce a distance between the front frame and the rear frame in a folded state,
wherein the handle structure comprises a cross-bar handle connecting a left side and a right side of the upper end of the front frame, and
wherein the front frame includes a base plate at the lower end configured to support a bottom of the golf bag.

2. The golf bag cart of claim 1, wherein the folding linkage comprises a Z-shaped linkage when folded configured to fold to minimize the distance between the front frame and the rear frame.

3. The golf bag cart of claim 1, wherein the cross-bar handle is telescopically adjustable in height relative to the front frame.

4. The golf bag cart of claim 3, wherein the cross-bar handle comprises a push-button locking mechanism to secure the handle at a selected height.

5. The golf bag cart of claim 1, further comprising a seat mounted between the front frame and the rear frame, wherein the seat is sized to extend rearward beyond the rear frame to provide clearance for a user's legs during walking.

6. The golf bag cart of claim 1, wherein the base plate has a semi-cylindrical shape with a depth of three inches or less and a diameter of ten inches or less.

7. The golf bag cart of claim 1, wherein the recessed accommodation groove has a rectangular cross-sectional profile to provide a flat contact surface for the golf bag.

8. The golf bag cart of claim 7, wherein the recessed accommodation groove includes a plurality of strap holes, including a pair of inner holes for securing a small-diameter golf bag and a pair of outer holes for securing a regular-diameter golf bag.

9. The golf bag cart of claim 5, wherein the front frame comprises three points of support for the golf bag: the base plate at the lower end, the recessed accommodation groove at a middle portion, and the seat at an upper portion.

10. The golf bag cart of claim 1, wherein the plurality of wheels has a diameter of approximately ten inches to facilitate movement over a rough terrain.

11. The golf bag cart of claim 1, wherein the plurality of wheels comprises front wheels having a diameter of approximately nine inches and rear wheels having a diameter of approximately ten inches.

12. The golf bag cart of claim 1, wherein the golf bag cart is configured as a dual golf bag cart, wherein the front frame comprises a parallel rack arrangement configured to support two golf bags side-by-side.

13. The golf bag cart of claim 12, wherein the front frame includes two distinct base plates and two distinct recessed accommodation groove sets to independently secure the two golf bags.
